(19) United States
(12) Patent Application Publication
(10) Pub. No.: US 2014/0124426 A1
(43) Pub. Date: May 8, 2014

(54) WASTEWATER TREATMENT

(71) Applicants: Joseph A. King, Wayzata, MN (US); John Hill, Plymouth, MN (US)

(72) Inventors: Joseph A. King, Wayzata, MN (US); John Hill, Plymouth, MN (US)

(21) Appl. No.: 14/049,041

(22) Filed: Oct. 8, 2013

Related U.S. Application Data
(63) Continuation-in-part of application No. 12/592,699, filed on Dec. 1, 2009.
Application No. 12/592,699 is a continuation-in-part of application No. 12/800,692, filed on May 20, 2010, now Pat. No. 8,591,748.

(51) Int. Cl. C02F 1/50

(52) U.S. Cl. CPC C02F 1/50
USPC 210/198.1

(57) ABSTRACT

An antimicrobial method of treating wastewater and a wastewater antimicrobial dispenser containing an antimicrobial agent for treating a body of wastewater to kill microorganisms by increasing the concentration metal ions therein. The antimicrobial method includes the step of increasing the effectiveness of the biocidal component in the body of wastewater to thereby lessen the need for a supplemental biocide by adding a compound containing a hydantoin ring where the compound containing a hydantoin ring may or may not have any antimicrobial properties. The antimicrobial agent including a source of biocidal metal ions and a compound containing a hydantoin ring where the antimicrobial agent may be a powder, a liquid a solid or combinations thereof.

### CROSS REFERENCE TO RELATED APPLICATIONS

This application is a continuation-in-part of pending U.S. application Ser. No. 12/592,699; filed on Dec. 1, 2009; titled WASTEWATER TREATMENT, which claims priority from U.S. provisional application 61/200,958 filed Dec. 5, 2008 titled WASTEWATER TREATMENT and is a continuation-in-part of pending U.S. application Ser. No. 12/800,692; filed on May 20, 2010, which is a continuation-in-part of U.S. application Ser. No. 12/315,285 filed Dec. 2, 2008 which is a continuation of application Ser. No. 11/999,654 filed on Dec. 6, 2007, which is a division of application Ser. No. 10/928,668 filed on Aug. 26, 2004, which is now U.S. Pat. No. 7,347,934.

### FIELD OF THE INVENTION

This invention relates generally to wastewater treatment and, more specifically to treatment of wastewater to kill microorganisms therein.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

An increase in the consumption of water for all types of uses as well as the quest for a cleaner environment generates a need to recycle all types of water including wastewater. Wastewater, which may be either residential or industrial wastewater, may be in various conditions and may include human waste, food scraps, oil, soaps and chemical. Household wastewater generally comes from household appliances, bathtubs, showers and toilets. Wastewater that is heavily polluted is often referred to as black water and household wastewater that does not include toilet waste is often referred to as greywater since, although polluted, it generally contains lesser amounts of pollutants. An example of a system for wastewater separation and wastewater treatment in shown in U.S. Pat. No. 6,299,775. While biocidal metals are effective in killing microorganisms one of the difficulties with killing microorganisms in wastewater with biocidal metals is that in the presence of wastewater the solubility of the biocidal metal ions may not be sufficiently high so as to effectively kill the microorganism in the wastewater. That is some biocidal metals, such as silver for example, have a tendency to complex with other compounds and become increasingly insoluble thereby reducing the effective microorganisms killing ability of the biocidal metals.

Another type of wastewater is found in industrial applications and industrial facilities where wastewater is used for a variety of tasks including cooling, cooking, manufacturing and other process that require the use of water that results in contamination of the water and requires that the wastewater be subject to an antimicrobial treatment before retuning the water to the environment.

Still other types of wastewater include water, which is used in the hold of ships for ballast. Conditions within the water storage can not only pollute the water with solids but also can cause growth of harmful microorganisms as well as transfer of harmful microorganisms from one geographical location to another geographical location as a ship picks up ballast water in one port and discharges the ballast at another port or at sea. Before the wastewater is discharged back into the sea or a reservoir the harmful microorganisms in the water, which is used as ballast, needs to be subjected to an antimicrobial treatment to kill the harmful microorganisms before the water is discharged.

### SUMMARY OF THE INVENTION

Briefly, the present invention comprises a method of killing microorganisms in wastewater with biocidal metal ions by elevating the concentration of available biocidal metal ions in the wastewater addition by including of an additive to the wastewater, which may or may not have any antimicrobial properties.

In one example the invention includes a dispenser with an antimicrobial agent comprising a compound containing a hydantoin ring and a biocidal metal ion source.

In another example the invention includes method of killing microbes in wastewater by adding a source of biocidal metal ions to the body of wastewater together with a compound containing a hydantoin ring to enhance the biocidal metal ion concentration to a level effective to kill the microorganisms in the wastewater.

In another example the compound containing a hydantoin ring may be tabletized, or be in liquid, powder or other solid form so the compound containing the hydantoin ring can be placed in a body of wastewater together with a source of biocidal metal ions to kill microorganisms the wastewater.

### BRIEF DESCRIPTION OF THE DRAWINGS

FIG. 1 discloses a system for treating wastewater;

FIG. 2 shows the concentrations of silver with and without the addition of DMH

FIG. 3 shows an example of a one-chamber dispenser;

FIG. 4 shows an example of a two-chamber dispenser; and

FIG. 5 shows a schematic of a hydantoin ring.

### DESCRIPTION OF THE PREFERRED EMBODIMENT

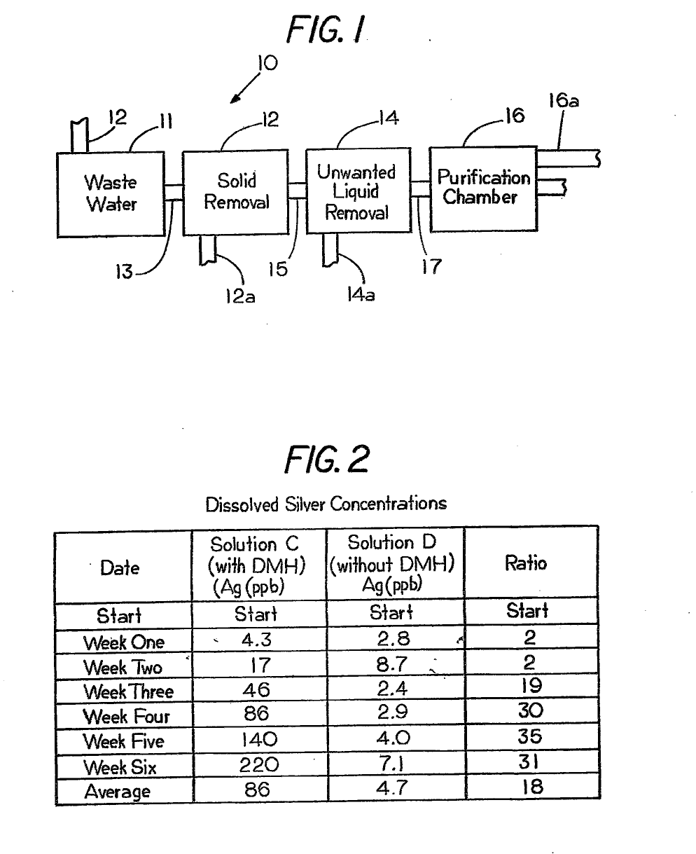

FIG. 1 discloses a wastewater treatment system 10 for recycling wastewater to a state where the water is either fit for human consumption, agricultural use or otherwise returned to the environment. Wastewater, of all types which includes but is not limited to residential wastewater, industrial wastewater, commercial wastewater and reservoir wastewater comes in various conditions and may include human waste, food scraps, oil, soaps and chemical. Household wastewater generally comes from household appliances, bathtubs, showers and toilets. Wastewater that is heavily polluted is often referred to as black water and household wastewater that does not include toilet waste is often referred to as greywater since, although polluted, it generally contains lesser amounts of pollutants.

Wastewater treatment system 10 includes a holding tank 11 that receives wastewater from an inlet pipe 12. In one application the wastewater can be from commercial, industrial or households septic systems and can be either greywater or blackwater. After arriving in the holding tank 11 the wastewater is pumped to a water treatment station 12 where solid or particle pollutants are removed from the wastewater. Solids may be removed through various methods including centrifuges or gravitation settling. The solid pollutants are removed through outlet 12a and the wastewater with the solid pollutants removed is then pumped through pipe 15 to another water treatment station 14 where unwanted liquids such as oils or soaps are removed from the wastewater and discharged through outlet 14a. Smaller particles or unwanted liquids may be removed by filters or the like. Once the unwanted liquids are removed from the wastewater the wastewater is pumped to water purification station 16 through pipe 17.

The amount and type of treatment of the wastewater in purification chamber 16 depends on the eventual use of water in purification chamber 16. For example, if the water in chamber 16 is to be used for human consumption the unwanted organisms in the wastewater need to be killed to render the water suitable for human consumption. One of the effective ways of killing harmful organisms, such as bacteria, in wastewater is the use of biocidal metals that release heavy metals ions and particularly heavy metals ions such as silver ions. Although silver ions are effective in killing harmful unwanted organisms the solubility of silver ions in water is limited and hence the effectiveness in quickly and effectively killing harmful bacterial is also limited.

While wastewater treatment involves the removal of pollutants in the wastewater the type of wastewater treatment required will depend on the type of wastewater being processed as well as the final use for the wastewater. For example, if the wastewater is to be used for human consumption one of the final processing steps includes the killing of harmful organism in the wastewater. In the process described herein wastewater is purified either partly or wholly through the use of a heavy metal ion donor that releases heavy metal ions such as silver ions. Although silver ions are effective in killing harmful organisms the low solubility of the silver ions in water limits the effectiveness of the silver ions to provide an effective and quick kill of harmful organisms in the wastewater. In the process described herein the effectiveness of the metal ions, particularly the silver ions, is enhanced through increasing the solubility of the silver ions by addition of the presence of a compound containing a hydantoin ring. That is, it has been discovered that if silver forms a complex with hydantoins, the silver will remain soluble to a higher degree thereby retaining the silver's antimicrobial activity.

FIG. 5 shows a schematic of the structure of a hydantoin ring with carbon and nitrogen atoms joined in a five-sided ring. An oxygen atom is attached to two of the carbons in the hydantoin ring. The lines extending from the third carbon atom and the nitrogen atom indicate that other atoms could be attached thereto. For example, in a compound containing a hydantoin ring, such as DMH (5,5-dimethylhydantoin), two methyl groups would be attached to the carbon atom an a hydrogen atom would be attached to each of the two nitrogen atoms.

Tests performed by the inventor in co-owned U.S. Pat. No. 7,347,934, which is incorporated by reference, has demonstrated that two halogenated hydantoins such as Bromochlorodimethylhydantoin (BCDMH) and Dibromodimethylhydantoin (DBDMH) when combined with a metal ion donor may be used in pools and spas to kill microorganisms (U.S. Pat. No. 7,347,934).

It has been found that a compound containing a hydantoin ring such as 5,5-dimethylhydantoin (DMH), which lacks antimicrobial properties, has the ability to interact with a source of metal ions to increase the solubility of the silver in wastewater to increase the effectiveness of the antimicrobial process in the wastewater. It has also been found that compounds containing a hydantoin ring, which have antimicrobial properties, such as Bromochlorodimethylhydantoin (BCDMH) and Dichlorodimethylhydatoin (DCDMH) Dibromodimethylhydantoin (DBDMH) or silverdimethylhydantoin (AgDMH) also interact to increase the solubility of silver in the presence of water. While a number of compounds with a hydantoin ring may be used as a practical matter one may want to avoid those compounds where the group or groups on the compound may have an adverse effect on the sanitized product.

Examples of other well known compounds wherein the compound contains a hydantoin ring include 1-hydroxymethyl-5,5-dimethlyl hydantoin, glycolyurea and Copper hydantoin, Hydantoin-5-acetic acid, and Imidazolidines including parabanic acid, 2-Thiohydantoin, hydantoin purum, hydantoin, 1-Aminohydantoin hydrochloride, 2-Imidazolidone, 2-Imidazolidone purum, 2-Imidazolidinethione, 2-hydrazino-2-imidazoline hydrobromide, 2-oxo-1-imidazolidinecarbonyl chloride, 1-methylhydantoin, 5-methylhydandtoin, 2-imidazolidone-4-carboxylic acid, allantoin, allantoin purum, creatinine anhydrous, creatinine biochemika, creatinine hydrochloride, 2-methyl-2-imidazoline, 2-methylithio-2-imdazoline hydrodide, 3-bromo-1-chlor-5-5-dimethlyhydantoin, 1-3-dibromo-5,5-dimethly hydantoin purium, 1-3-dichlorol-5,5-dimethylhydantoin, 1,3-dichlor-5,5-dimethylhydantoin, hydantoin-5-acetic acid. 2-chlorocarbonyl-1-methanesulfonyl-2imidazolidinone. 5,5-dimethylhydantoin purum. 5,5-dimethylhydantoin, 2-imino-1-imidaolidineacetic acid, 1,3-dimethyl-2-imidazolidinone puriss, 1,3-dimethly-2-imidazolidinone purum, 1,3-dimethyl-2-imidazolidinone, 1-(2-hydroxyethyl)-2-imdazolinone, 1,5,5-trimethlylhydantoin, 5-ethyl-5-methylhydantoin, 2-phenyl-2-imidazoline purum, 2-(4,5-dihydro-1h-imidazoyl)-2-phenol, 4-(4,5-dihydro-1H-imidazol-2yl) phenylamine, 5-methyl-5-phentylhydantoin, 2-benzylimidazoline, 4-(4-methyl-4,5-dihydro-1H-imidazol-2-yl)phenyl, Imidazolidinyl urea, 4-hydroxymephenyloin, triethoxy-3-(2-imidazolin-1-yl)propysiliane purum, 1,(p-tosyl)-3,4,4-trimethylimidazolidine, naphazoline nitrate puriss, 5,5,diphenyl-2-thiohydantoin, 5-(4-hydroxyphenyl)-50phenylhydantion, 5-(p-methylphenyl)-5-phenyhydantoin, 1,3,bisbensyl-2-oxoimidazoline-4,5-dicarboxylic acid. Other examples of hydantoins are listed in European patent EP0780125, which is hereby incorporated by reference. The above list compounds with a hydantoin ring is illustrative and no limitation thereto is intended.

Tests of a silver ion donor in the presence of DMH in a body of water reveals that the dissolved silver concentrations are higher than anticipated when compared to a body of water with the silver ion donor but without the DMH. The results suggest that DMH interacts with silver to form a soluble complex even if the source(s) of silver are from insoluble salts such as silver bromide, which in some cases may be derived from silver chloride.

In order to verify that a compound containing a hydantoin ring, such as, DMH interacts to increase the solubility of insoluble silver in a body of water, a test was performed using either silver chloride or silver bromide as the donor of silver metal ions. The test demonstrated the enhancement of the silver ion concentration in a water environment when DMH is used in combination with the source of silver ions even though the DMH lacked any independent antimicrobial properties.

### EXAMPLE

Silver bromide was initially prepared from a saturated sodium bromide solution, combined with silver nitrate in solution. The yellow precipitate, silver bromide, was than purified by filtration and washing. Additionally, the solid was allowed to dry before use.

A buffer system having a pH of 7.41 was prepared by adding Fisherbrand® potassium phosphate monobasic-sodium phosphate dibasic buffer to 2 Erlenmeyer flasks filled with 1000 mL of purified water. The first flask was treated with 1.12 grams of 5,5-dimethylhydantoin (DMH) and marked solution “C” (with DMH) and the second flask was left untreated and marked solution “D” (without DMH) for control. In regards to the 5,5-dimethylhydantoin (DMH), the 5,5-dimethylhydantoin (DMH) comprised 97% reagent grade was obtained from Aldrich (CAS No. 77-71-4, Cat. No. D161403-1KG).

After the initial set-up, approximately 0.10 grams of dried silver bromide was introduced into a dialysis tubing (Fisherbrand®, 45 mm, MWCO 12,000-14,000) along with purified water. The ends of the dialysis tubing were clamped to contain the silver bromide and purified water. Next, the outside of the dialysis tubing was rinsed several times to ensure that silver bromide residue was not on the outside of the dialysis tubing. A string was then tied to one clamp, and one tube was introduced into each flask. A magnetic stir bar was used to mix the solutions.

During the period of the test, a 100 ml sample were removed from solution “D” (without DMH) and solution “C” (with DMH) at weekly intervals and analyzed for their pH using Orin Perphect Meter 370 and analyzed for their silver ion concentrations using atomic absorption spectrometry.

FIG. 2 shows a table containing a list of the dissolved silver concentration, in parts per billion (ppb) obtained from the 100 ml samples for solution “D” (without DMH) and solution “C” (with DMH) at each of their respective weekly time intervals. The average concentration of dissolved silver for solution “C” (with DMH) was 86 ppb while solution “D” (without DMH) had an average concentration of dissolved silver of 4.7 ppb.

A week after the start date, the concentration of dissolved silver for solution D (without DMH) was at 43 ppb, while the concentration of dissolved silver for solution C (with DMH) was at 2.8 ppb. By the end of the testing, 6 weeks later, the concentration of dissolved silver for solution C (with DMH) had increase to 220 ppb, while the concentration of dissolved silver for solution D (without DMH) was 7.1 ppb. That is, by the end of the 6 weeks test, the concentration of dissolved silver was at least 30-fold greater in solution C (with DMH) then for solution D, (without DMH).

In summary, the results of the above testing confirmed that in a solution containing silver bromide, the presence of compound containing a hydantoin ring, such as DMH, leads to a higher dissolved silver concentrations than compared to a control solution containing silver bromide without the presence of the DMH. These results suggest that compounds containing a hydantoin ring, which may not have any antimicrobial properties, can interact with silver to form a soluble complex even if the source of silver comprises an extremely insoluble silver salt such as silver bromide.

In regards to generating a level of silver ions in a body of water, the King Technology, Inc. Frog® Mineral Cartridge is known to provide silver ions in the form of solid silver chloride (AgCl) distributed over a porous matrix. Water flowing through the matrix comes into contact with the AgCl resulting in the release of soluble silver ions to water. DMH was also released into the water resulting in the formation of ionic-hydantoin structures. It would be anticipated that soluble silver ions would be depleted from water through the formation of silver bromide, an insoluble salt. However, as shown in FIG. 2 after the DMH was added to the water, the actual silver concentrations were higher than the calculated theoretical silver concentration.

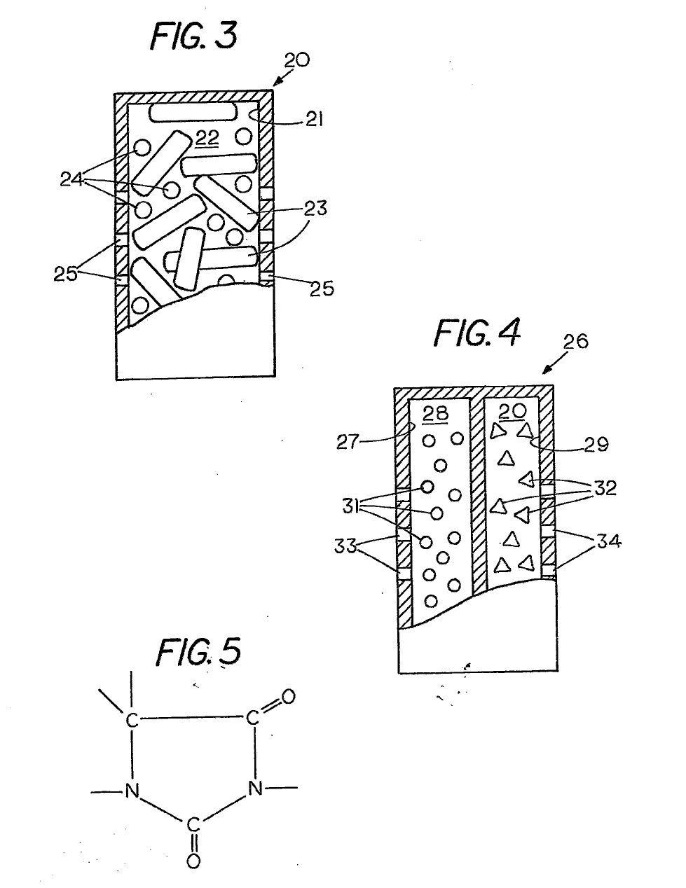

Referring to FIGS. 3 and 4, FIG. 3 shows a dispenser 20 having a housing 21 containing a compartment 22 therein for the compound containing the hydantoin ring and a source of biocidal metal ions such as silver ions. Located in compartment 22 is a compound 23 containing a hydantoin ring such as DMH and a biocidal component such a biocidal metal for generating biocidal metal ions into a body of wastewater. Although various types of biocidal metal such as zinc or copper may be use, the preferred biocidal metals comprise silver, silver alloy or some combination thereof, because of the recognized bactericidal, viricidal, and algaecidal properties of silver. The biocidal metals can be introduced as metallic, zero valence material, or as metal ions that can be introduced into the water by dissolution of soluble metal salts, or by the dissolution of the metal itself. For example, silver ion can be introduced into the water through the dissolution of silver nitrate, or through the dissolution of metallic silver as the result of conversion to silver oxide and subsequent conversion of the oxide to more soluble silver species. Mixtures of different salts, or of salts with metallic material, may be combined together to provide the necessary concentration of metal ions in the water. In the embodiment of FIG. 3, the biocidal metal is in a dry or inactive state and comprises either metallic silver or a source of silver ions, such as silver chloride 24. Similarly, the compound containing the hydantoin ring is also in a dry or inactive state, with both compound containing the hydantoin ring and the silver chloride entering into an active state in the presence of wastewater. A set of openings 25 allows water access to compartment 22 and to the source of the compound containing a hydantoin ring 23 and the source of silver ions 24.

It is noted that various insoluble or slightly soluble transition metal salts may also be used in the present invention as a source of silver ions. Examples of insoluble or slightly soluble transition metal salts suitable for use in the present invention include, but are not limited to, AgCl, AgBr, AgI, Ag₂S, Ag₃PO₄, NaAg₂PO₄, CuS, and NaCuPO₄. Other examples of silver compounds include, but are not limited to, AgNO₃, Ag₂CO₃, AgOAc, Ag₂SO₄, Ag₂O, [Ag(NH₃)₂]Cl, [Ag(NH₃)₂]Br, [Ag(NH₃)₂]I, [Ag(NH₃)₂]NO₃, [Ag(NH₃)₂]₂SO₄, silver acetoacetate a silver benzoate, a silver carboxylate, silver amine complexes such as [Ag(NR₃)₂]X, where R is an alkyl or aryl group or substituted alkyl or aryl group and X is an anion such as, but not limited to, Cl⁻, Br⁻, I⁻, OAc⁻, NO₃⁻ and SO₄²⁻.

FIG. 4 shows a further example of wasterwater treating system including a dispenser 26 having a first housing 27 containing a compartment 28 and a second housing 29 with a compartment 30 therein. Located in compartment 28 is a silver ion donor such as metallic silver 31 and located in compartment 30 is a source of compound 32 containing a hydantoin ring such as DMH. A set of openings 33 allows water access to compartment 28 and to the metallic silver 31. Similarly, a set of openings 34 allows water access to compartment 30 and the source of DMH.

Although the use of the silver ion donor such as silver, silver oxide, silver salt, or a combination thereof have been disclosed in the present invention, various types of silver alloys may also be used. The silver may be used standing along in its pure/elemental or alloyed form or coated or impregnated to a substrate and placed in compartment 28. In addition, other types of silver ion donors, other types of transition metal, a transition metal oxide, or a combination thereof, and other alternative bactericides whose solubility can be changed in the presence of DMH can also be used in the present invention.

In regards to the source of DMH 23, 32 of FIGS. 3 and 4, note that FIG. 3 shows source of compound containing a hydantoin ring 22 in particle form with the aforementioned particles having an initial size that is larger than the size of opening 23 to prevent the particles from escaping through opening 23. FIG. 3 shows source of compound containing a hydantoin ring 23 in tablet form. In regards to the tablets, it is noted that various types of material, including but not limited to microcrystalline cellulose (MCC), may be used as a binder in the formation of the santizing tablets which are tabletized with a metal ion donor so that both the compound containing a hydantoin ring and the metal ion donor can be placed in the body of fluid to be treated.

It is also noted that the preferred level of the compound containing a hydantoin ring in this case which is DMH is present in the body of wastewater is between 5 and 25 ppm with the DMH and the source of silver cooperating to maintain a level of silver ions present in the amount of 1 to 3 ppb and/or alternatively cooperating to maintain a level of silver ions present to sustain a standard plate count at 35 degrees F. of less than 200 colonies per milliliter.

Thus the invention includes an antimicrobial agent for killing microorganisms in a body of wastewater wherein the antimicrobial agent includes a source of biocidal metal ions releasable into the body of wastewater to generate an antimicrobial level of biocidal metals that may be insufficient to kill the microorganisms in the body of wastewater and a compound containing a hydantoin ring releasable into the body of wastewater wherein the compound containing the hydantoin ring increases the antimicrobial level of biocidal metal ions in the body of wastewater to a biocidal level sufficient to kill microorganism in the wastewater.

The present invention further includes a device and method for using metal ion donors in combination with hydantoins including unhalogenated hydantoins such as 5,5-dimethylhydantoin (hereinafter “DMH”) to enhance a concentration of the metal ions in the body of wastewater or to enhance the solubility of metal ions from other metal ion donors to retain the metal ions' antimicrobial activity in the body of wastewater.

The invention also includes the step of placing the dispenser 20, 26 containing both the source of compound 23 containing a hydantoin ring, and the source of silver ions 24, 31 in the body of wastewater and allowing water to come into contact with the DMH 33, 32 and the source of silver ion 24, 31 to periodically release DMH and silver ions into the body of wastewater. As the DMH is released into the body of wastewater, the DMH is carried to the source of silver ions 24, 31 and interacts with the source of silver 24, 31 to increase the solubility of the silver ions to allow for the release of more silver ions into the body of wastewater than if the source of silver ions 24, 31 alone thereby increasing the level of silver ions to a level sufficient to kill the microorganisms in the wasterwater.

The invention also include a method of treating a body of wastewater to kill microorganisms by enhancing the microbial agents comprising the steps of (1) adding a biocidal component 14, 21 to the body of wastewater; and (2) adding a concentration of compound containing a hydantoin ring such as 5,5-dimethylhydantoin 13, 22 to the body of wastewater to enhance the effectiveness of the biocidal component 14, 21 in the body of wastewater to thereby lessen the need for a supplemental biocide. The aforementioned method can also include the steps of (3) adding a transition metal, a transition metal oxide, a transition metal salt, or a combination thereof to the body of wastewater; (4) adding silver, silver oxide, silver salt, or a combination thereof to the body of wastewater; (5) adding a substrate that has been coated or impregnated with metallic silver, silver salt, or a combination thereof to the body of wastewater; (6) a silver alloy to the body of wastewater; (7) adding silver nitrate to the body of wastewater; (8) adding a carrier containing a silver deposit to the body of wastewater; (9) adding a silver-containing material to the body of wastewater; (10) placing a dispenser 10, 16 containing both the biocidal component 14, 21 and the 5,5-dimethylhydantoin 13, 22 in the body of wastewater and allowing water to come into contact with both the biocidal component 14, 21 and the 5,5-dimethylhydantoin 13, 22; (11) adding an amount of 5,5-dimethylhydantoin 13, 22 in the body of wastewater to obtain a final concentration of at least 5 ppm 5,5-dimethylhydantoin; and adding a supplemental water disinfection system comprising sodium bromide.

The invention further includes a method of treating a body of wastewater to kill microorganisms by increasing the effectiveness of an antimicrobial agents comprising the steps of: (1) adding a source of biocidal metal 14, 21 to the body of wastewater to generate biocidal metal ions in the body of wastewater; and (2) adding compound containing a hydantoin ring such as 5,5-dimethylhydantoin 13, 22 to the body of wastewater to interact with the biocidal metal 14, 21 to enhance the biocidal metal ion concentration in the body of wastewater. The aforementioned method can also include the steps of (3) adding a source of metallic silver to the body of wastewater; (4) adding metallic silver alloy 14, 21 to the body of wastewater; (5) placing a dispenser 10, 16 containing both the source of biocidal metal 14, 21 and the compound containing a hydantoin ring such as 5,5-dimethylhydantoin 13, 22 in the body of wastewater and allowing water to come into contact with both the source of biocidal metal 14, 21 and the 5,5-dimethylhydantoin 13, 22; (6) adding a metallic silver coated or impregnated substrate 14, 21 to the body of wastewater; and adding a source of pure silver 14, 21 to the body of wastewater.

Thus, as described herein one example a wastewater antimicrobial agent may include a biocidal metal selected from the group consisting of silver chloride, a metallic silver alloy, pure silver or a substrate impregnated with metallic silver and the compound containing the hydantoin ring where the compound containing the hydantoin ring may be either a non-halogenated hydantoin such as 5,5-dimethylhydantoin (DMH) or a halogenated hydantoin including Bromochlorodimethylhydantoin (BCDMH) or Dichlorodimethylhydatoin (DCDMH) or combinations thereof and the compound containing the hydantoin ring is in either a liquid state or a dry state including, powder, solid, granules, pellets or combinations thereof.

I claim:

1. A wastewater antimicrobial dispenser for killing microorganisms in a body of wastewater comprising:
a dispenser containing a source of biocidal metal ions releasable into the body of wastewater to generate a sanitizing level of biocidal metals insufficient to kill the microorganisms in the body of wastewater and a compound containing a hydantoin ring releasable into the body of wastewater wherein the compound containing the hydantoin ring increases the antimicrobial level of biocidal metal ions in the body of wastewater to a biocidal level sufficient to kill microorganism in the wastewater.

2. The wastewater antimicrobial dispenser of claim 1 including:
a first housing having a water accessible compartment containing the biocidal metal; and
a second housing having a water accessible compartment containing the compound containing a hydantoin ring.

3. The wastewater antimicrobial dispenser of claim 1 wherein the source of biocidal metal comprises silver chloride and the compound containing a hydantoin ring comprises 5,5-dimethylhydantoin.

4. The wastewater antimicrobial dispenser of claim 1 wherein the biocidal metal is selected from the group consisting of a metallic silver alloy, pure silver or a substrate impregnated with metallic silver and the compound containing the hydantoin ring is either 5,5-dimethylhydantoin (DMH) Bromochlorodimethylhydantoin (BCDMH) or Dichlorodimethylhydatoin (DCDMH) or combinations thereof wherein the compound containing the hydantoin ring is either a powder, a liquid, a solid or combinations thereof.

5. The wastewater antimicrobial dispenser of claim 1 wherein the compound containing a hydantoin ring lacks biocidal effectiveness to kill microorganisms.

6. The wastewater antimicrobial dispenser of claim 1 wherein the compound containing the hydantoin ring is in tablet form.

7. The wastewater antimicrobial dispenser of claim 1 wherein the compound containing the hydantoin ring is in tablet form and the source of biocidal metal ions are in tablet form.

8. A wastewater antimicrobial dispenser for killing microorganisms in a body of wastewater comprising:
a first housing having a water accessible compartment containing a source of biocidal metal ions releasable into the body of wastewater to generate a sanitizing level of biocidal metals insufficient to kill the microorganisms in the body of wastewater; and
a second housing having a water accessible compartment containing a compound containing a hydantoin ring releasable into the body of wastewater wherein the compound containing the hydantoin ring increases the antimicrobial level of biocidal metal ions in the body of wastewater to a biocidal level sufficient to kill microorganism in the wastewater, the compound containing the hydantoin ring selected from the group consisting of a metallic silver alloy, pure silver or a substrate impregnated with metallic silver and the compound containing the hydantoin ring is either 5,5-dimethylhydantoin (DMH), Bromochlorodimethylhydantoin (BCDMH) or Dichlorodimethylhydatoin (DCDMH) or combinations thereof.

9. The wastewater antimicrobial dispenser of claim 8 wherein the compound containing a hydantoin ring lacks biocidal effectiveness to kill microorganisms.

10. The wastewater antimicrobial dispenser of claim 8 wherein the source of biocidal metal ions comprises a transition metal, a transition metal oxide, a transition metal salt, or a combination thereof.

11. The wastewater antimicrobial dispenser of claim 8 wherein the source of biocidal metal ions comprises silver, silver oxide, silver salt, or a combination thereof.

12. The wastewater antimicrobial dispenser of claim 8 wherein the source of biocidal metal ions comprises a silver-containing material, a silver alloy or a silver nitrate and the compound containing a hydantoin ring lacks biocidal effectiveness to kill microorganisms.
